(19) United States
(12) Patent Application Publication
(10) Pub. No.: US 2009/0266431 A1
(43) Pub. Date: Oct. 29, 2009

(54) SPOOL WITH TWO-SIDED EFFLUENT

(75) Inventor: Mei-Li Chen, Tanzih Township (TW)

Correspondence Address: EGBERT LAW OFFICES, 412 MAIN STREET, 7TH FLOOR, HOUSTON, TX, 77002, US

(73) Assignee: Kuching International Co., Ltd., Tanzih Township (TW)

(21) Appl. No.: 12/111,052

(22) Filed: Apr. 28, 2008

(51) Int. Cl. A01G 25/16

(52) U.S. Cl. 137/625

(57) ABSTRACT

The present invention provides a spool of a faucet with a two-sided effluent structure to improve the shortcomings of a faucet spool with the known cold/hot water switching structure. The spool includes a spool assembly mounted into the valve shell. A valve base is placed at bottom of the valve shell and is provided with a cold water inlet, hot water inlet and two water outlets. The cold and hot water inlets are arranged centrally onto the bottom of the valve base, while two water outlets are assembled separately but symmetrically at both ends of cold and hot water inlets. When the spool is arranged separately onto the wall, the configuration of cold and hot water inlet pipes are greatly simplified to reduce the configuration cost of pipelines with improved applicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a spool, and more particularly to an innovative spool with a two-sided effluent structure.

2. Description of Related Art Including Information Disclosed Under 37 CFR 1.97 and 37 CFR 1.98

Generally, faucet structure enables control of cold, hot or warm water by switching the spool within the faucet handle. When the faucet is used by the operator, the faucet handle is typically rotated from right to left (counter-clockwise), and the cold water is gradually heated to warm water and then hot water. Such faucets with a directional switching structure are commonly used in complex buildings such as hotels or apartment buildings.

However, there are shortcomings are observed during actual applications.

The apartments of some hotels or apartment buildings are often configured symmetrically, so the water channels or water pipelines of the toilets/shower rooms are often arranged symmetrically. In response to typical symmetrical configuration of faucet structures in the left and right rooms, the cold/hot water pipelines must be staggered, thus leading to a complex wall-mounted pipeline configuration, higher construction costs and inconvenient maintenance.

To save more installation cost of the pipelines, the industrial operators enable cold and hot water pipelines to be linked by using pipeline connection technology. But, corresponding spool structures must be manufactured by spool manufacturers for matching such pipeline configurations. This will not only raise the manufacturing cost of spools, but also place restriction on the range of applications of each spool structure. Moreover, two types of spools must be considered carefully during installation process. Any error of installation will lead to failure of water discharge from the faucet and subsequent removal and reassembly. For this reason, a failure-proof structure shall be mounted onto the faucet with relatively high manufacturing costs.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

There is enhanced efficacy of the present invention.

Based upon the present invention, cold and hot water inlets are arranged centrally onto the valve base, and two water outlets are assembled symmetrically. A brake rod is limited through the limiting snapper to change the initial locating point of the upper ceramic disc. Referring to FIGS. 4 and 7, such a structure greatly simplifies the configuration of cold and hot water inlet pipes, thus reducing significantly the construction and maintenance costs with better applicability.

Since cold and hot water inlets are arranged centrally along with two symmetrical water outlets, no symmetry issue is considered during assembly of spool structure. The spool manufacturers are not required to fabricate another spool for the faucet body, thus reducing greatly the manufacturing cost of the spool and expanding its range of application in the market.

There are also improvements brought about by this invention.

Based upon the configuration that the lower body is provided with an internal locating portion and external locating portion, along with lower ceramic disc, the area of the ceramic disc could be expanded to increase water outflow.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 depicts an exploded perspective view of the present invention.

FIG. 2 depicts an assembled perspective view of the present invention.

FIG. 3 depicts a side elevational view of the present invention.

FIG. 4 depicts a sectional view of the initial locating point of upper ceramic disc of the present invention.

FIG. 5 depicts a cross-sectional view of operation of the present invention.

FIG. 6 depicts another side elevational view of the application of the present invention.

FIG. 7 depicts another sectional view of the initial locating point of the upper ceramic disc of the present invention.

FIG. 8 depicts another sectional view of the operation of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

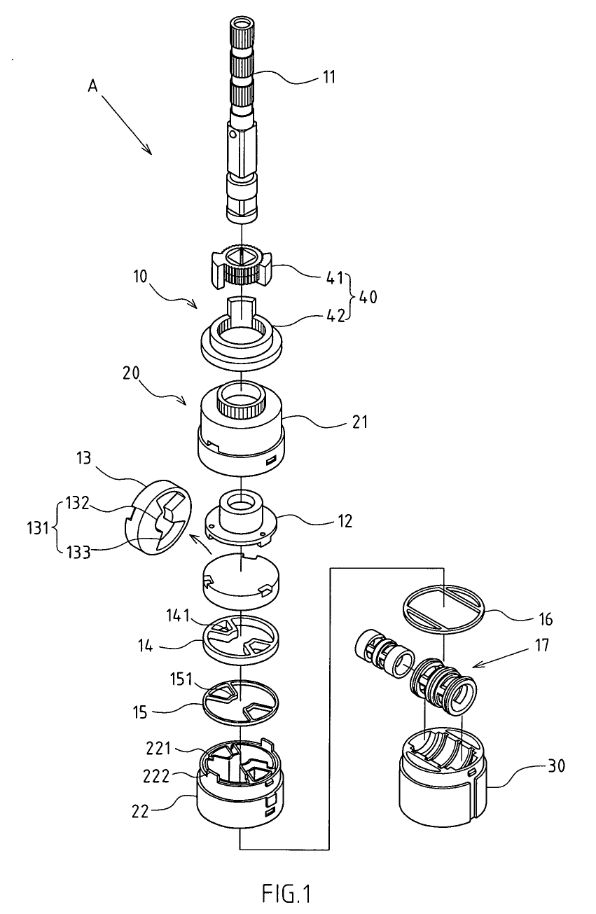

FIGS. 1-8 depict preferred embodiments of the spool with a two-sided effluent structure of the present invention. The embodiments are provided for only explanatory purposes with respect to the patent claims.

Referring to FIGS. 1-2, said spool A comprises a spool assembly 10, mounted into the valve shell 20; and a valve base 30 is placed at bottom of the valve shell 20, the valve base 30 being provided with cold water inlet 31, hot water inlet 32 and two water outlets 33. The cold, hot water inlets 31, 32 are arranged centrally onto the bottom of the valve base 30, while two water outlets 33 are assembled separately but symmetrically at both ends of cold, hot water inlets 31, 32.

The valve shell 20 is composed of an upper body 21 and a lower body 22. The spool assembly 10 comprises a brake rod 11, a locator 12, an upper ceramic disc 13, a lower ceramic disc 14 and a sealing gasket 15 arranged between upper body 21 and lower body 22 of valve shell 20, as well as inner copper sheathing 16 and equilibrated valve 17 arranged between lower body 22 and valve base 30. The upper and lower bodies 21, 22, or the lower body 22 and valve base 30 are mated securely by means of snapping.

The upper ceramic disc 13 is available with a butterfly-like inside recess 131, which is composed of a central circular groove 132 and a sectorial groove 133 that penetrates symmetrically both sides of the central circular groove 132.

A limiting snapper 40 is arranged between the upper body 21 and brake rod 11. The limiting snapper 40 is composed of a limiting sheath 41 and a limiting ring 42. Moreover, the initial locating point of upper ceramic disc 13 could be changed through the configuration of the limiting sheath 41 and limiting ring 42.

The lower ceramic disc 14 is provided symmetrically with switching portions 141, such that the sealing gasket 15 is provided with embedding portions 151 corresponding to the switching portions 141. The lower body 22 is provided with an internal locating portion 221 for positioning the switching portion 141 of the lower ceramic disc 14, and an external locating portion 222 mating with the upper body 21. With this structural configuration, it is possible to increase the area of ceramic disc of spool A for bigger water outflow.

Based upon above-specified structures, the present invention operates as follows:

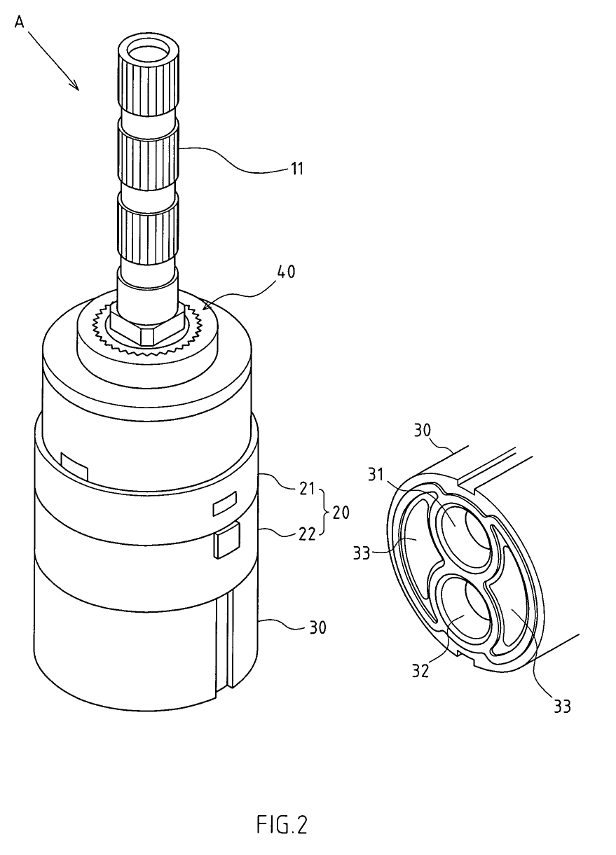

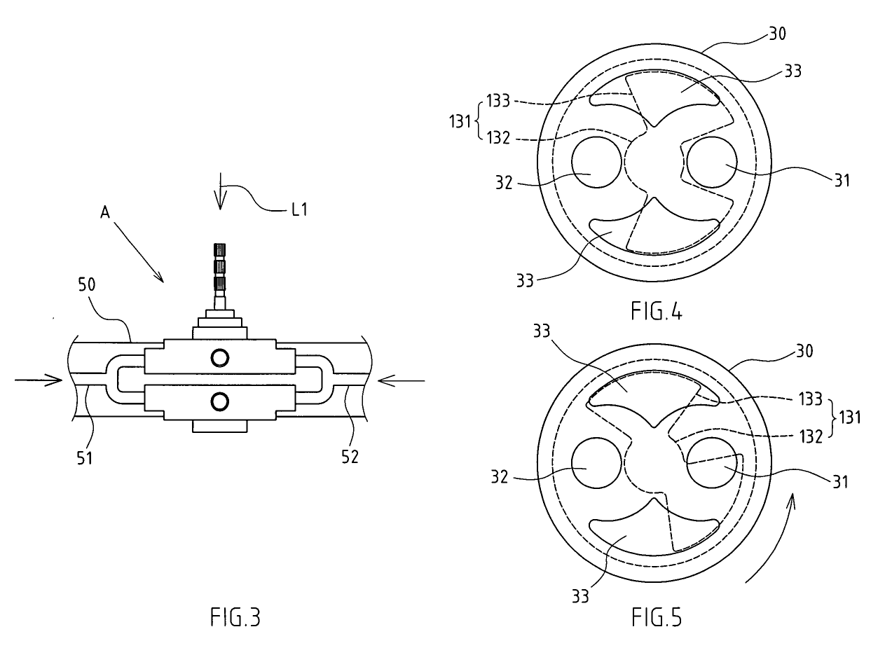

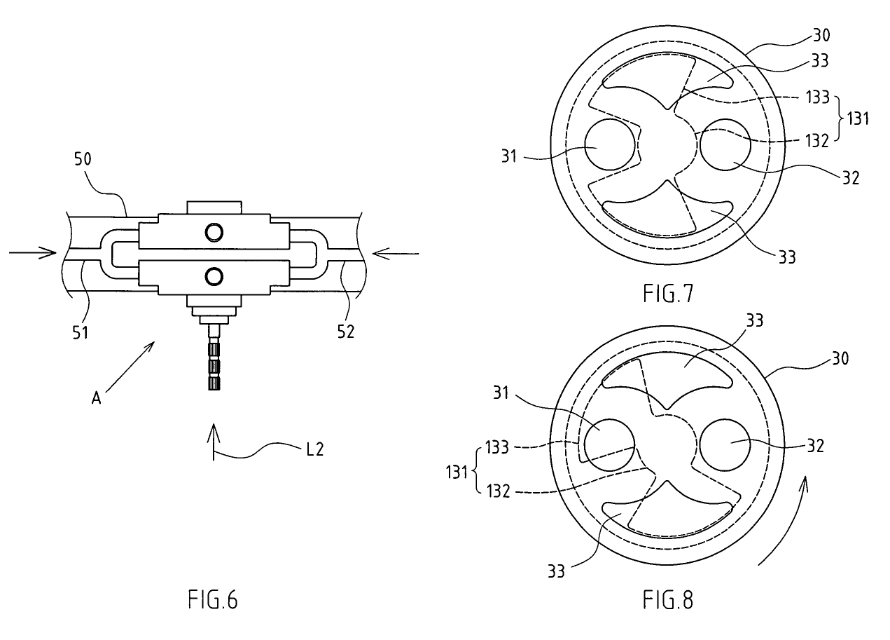

Spool A is assembled opposite at both sides of the wall 50, wherein cold water inlet pipe 51 and hot water inlet pipe 52 are arranged as illustrated in FIGS. 3 and 6.

FIG. 3 depicts the internal structure of spool A as shown by arrow L1. FIG. 4 depicts the configuration of initial locating point of inside recess 131 within upper ceramic disc 13, which could be changed through the configuration of the limiting sheath 41 and limiting ring 42. Since two sectorial grooves 133 are not overlapped with cold water inlet 31 or hot water inlet 32, no water is discharged from the faucet water outlet. Referring to FIG. 5, if the faucet handle is turned to drive the brake rod 11 for counter-clockwise rotation, the sectorial groove 133 at one side of the upper ceramic disc 13 will contact with the cold water inlet 31, allowing cold water to flow out from both sides of the water outlet 33. If rotation continues, the sectorial grooves 133 at both sides will contact separately with cold and hot water inlets 31, 32, warm water flow will occur, followed by hot water flow, until the upper ceramic disc 13 is turned to the final locating point as shown in FIG. 7.

FIG. 6 depicts the internal structure of spool A as shown by arrow L2. FIG. 7 depicts the configuration of initial locating points within upper ceramic disc 13 based on assembly of limiting sheath 41 and limiting ring 42. Referring to FIG. 8, if the faucet handle is turned counter-clockwise, the sectorial groove 133 at one side of the upper ceramic disc 13 will contact the cold water inlet 31, allowing cold water to flow out from both sides of the water outlet 33.

In sum, spool A of the present invention is designed in such a manner that two water outlets 33 are arranged at both ends of spool A, thus ensuring easy installation and better applicability without consideration of clockwise and counter-clockwise alignment.

Additionally, the present invention enables automatic regulation of supply water temperature through the configuration of equilibrated valve 17.

1. A spool for a faucet, said spool comprising:
a spool assembly mounted into a valve shell;
a valve base placed at a bottom of said valve shell said valve base having a cold water inlet, hot water inlet and two water outlets, said cold water inlet and said hot water inlet being arranged centrally onto said bottom of said valve base, said two water outlets being assembled separately and symmetrically at both ends of the cold, hot water inlets.

2. The spool defined in claim 1, wherein said valve shell is comprised of an upper body and a lower body, said spool assembly comprising a brake rod, a locator, an upper ceramic disc, a lower ceramic disc and a sealing gasket arranged between an upper body and a lower body of said valve shell, as said lower body and said valve base having inner copper sheathing and an equilibrated valve arranged between said lower body and said valve base, said upper body being in snap-fit engagement with said lower or said lower body being in snap-fit engagement with said valve base.

3. The spool defined in claim 2, wherein said upper ceramic disc has a butterfly-like inside recess, the recess having a central circular groove and a sectorial groove, said sectorial groove symmetrically penetrated through both sides of said central circular groove.

4. The spool defined in claim 2, further comprising:
a limiting snapper being arranged between said upper body and said brake rod, and being comprised of a limiting sheath and a limiting ring, said upper ceramic disc having an initial locating point changed through configuration of said limiting sheath and said limiting ring.

5. The spool defined in claim 2, wherein said lower ceramic disc is provided symmetrically with switching portions, said sealing gasket having embedding portions corresponding to said switching portions.

6. The spool defined in claim 2, wherein said lower body is provided with an internal locating portion, said lower ceramic disc being positioned by said internal locating portion, said upper body mating with an external locating portion.
